(19) United States
(12) Patent Application Publication
(10) Pub. No.: US 2007/0229555 A1
(43) Pub. Date: Oct. 4, 2007

(54) Electronic device and operation controlling method thereof

(76) Inventors: Hiroyuki Tsuji, Ome-shi (JP); Hiroshi Aiba, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/725,418

(22) Filed: Mar. 19, 2007

(30) Foreign Application Priority Data
Mar. 30, 2006 (JP) 2006-094797

(51) Int. Cl. G09G 5/02

(52) U.S. Cl. 345/694

(57) ABSTRACT

According to one embodiment, an electronic device in which a display unit is detachable from a device body and the display unit and the device body are able to make wireless communication with each other when the display unit is detached from the device body, the electronic device includes a collating unit which collates authentication information assigned to the display unit when the display unit is connected to the device body, and a changing unit which changes a resolution of the display unit to a preset resolution corresponding to the authentication information when collating the authentication information by the collating unit is completed.

### CROSS-REFERENCE TO RELATED APPLICATIONS

This application is based upon and claims the benefit of priority from Japanese Patent Application No. 2006-094797, filed Mar. 30, 2006, the entire contents of which are incorporated herein by reference.

### BACKGROUND

1. Field

One embodiment of the invention relates to an electronic device in which a display unit can be detached from a device body and an operation controlling method thereof.

2. Description of the Related Art

It is disclosed by, for example, in some electronic devices such as notebook-type personal computers, a display unit can be detached from a main body of the device and, in the detached state, the display unit and the device body can make wireless communication with each other. For example, JP-A No. 2003-345463 (KOKAI) discloses a notebook-type computer comprising a display which can be detached from a device body and operated as a wireless tablet personal computer. Besides the general mode, the electronic device of this kind generally has a power saving mode (sleep mode, hibernation mode) for reduction of the power consumption as operation modes. A number of electronic devices have the function by which the operation mode of the electronic device is shifted to the power saving mode and the power supply of the electronic device is turned off, for example, if an input operation made by the user continues for a certain period. The electronic devices can thereby reduce unnecessary power consumption.

However, even after the display unit is detached from the device body, the display unit is operated with the same resolution as that when the display unit is connected to the device body, and its power consumption is great. In addition, when the display unit is connected to the device body, the display unit is not authenticated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outer appearance of a tablet-type detachable personal computer according to an embodiment of the invention;

FIG. 2 is an exemplary perspective view showing the detachable personal computer shown in FIG. 1 in the tablet style according to the embodiment;

FIG. 3 is an exemplary block diagram showing a system configuration of a computer body shown in FIG. 1 according to the embodiment;

FIG. 4 is an exemplary block diagram showing a system configuration of a display unit shown in FIG. 1 according to the embodiment;

FIG. 5 is an exemplary illustration of signal flow in a case where the display unit is connected to the computer body according to the embodiment;

FIG. 6 is an exemplary illustration of signal flow in a case where the display unit is detached from the computer body according to the embodiment;

FIG. 7 is an exemplary illustration showing an example of a basic setting screen implemented by a setting unit of utility shown in FIG. 5 according to the embodiment;

FIG. 8 is an exemplary illustration showing an example of setting contents according to the embodiment;

FIG. 9 is an exemplary flowchart showing an operation in a case where the display unit is connected to the computer body according to the embodiment;

FIG. 10 is an exemplary flowchart showing an operation in a case where the display unit is detached from the computer body according to the embodiment;

FIG. 11 is an exemplary illustration showing an example of setting contents according to the embodiment; and

FIG. 12 is an exemplary perspective view showing a detachable personal computer which is not a tablet PC according to the embodiment.

### DETAILED DESCRIPTION

Various embodiments according to the invention will be described hereinafter with reference to the accompanying drawings. In general, according to one embodiment of the invention, an electronic device in which a display unit is detachable from a device body and the display unit and the device body are able to make wireless communication with each other when the display unit is detached from the device body, the electronic device comprises: a collating unit which collates authentication information assigned to the display unit when the display unit is connected to the device body; and a changing unit which changes a resolution of the display unit to a preset resolution corresponding to the authentication information when collating the authentication information by the collating unit is completed.

An embodiment of the present invention is described with reference to the accompanying drawings.

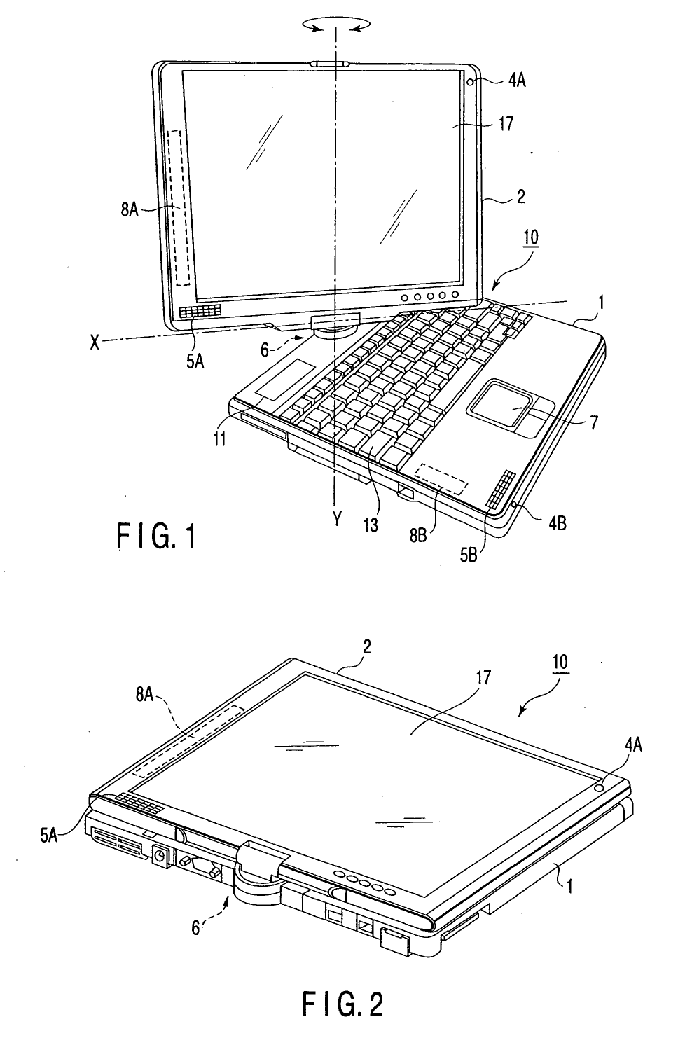

First, a configuration of an electronic device according to the embodiment of the present invention is described with reference to FIG. 1 to FIG. 4. The electronic device is implemented as a battery-operated tablet-type detachable personal computer 10. The detachable personal computer 10 of the present invention can reduce the power consumption by automatically changing the resolution to lower resolution when the display unit 2 is detached from the computer 10, and can execute the authentication processing and maintain the security when the display unit 2 is attached to the computer 10.

FIG. 1 is a perspective view showing the detachable personal computer 10 with the display unite opened. The computer (electronic device) 10 is composed of a computer body (electronic device body) 1 and a display unit 2. The display unit 2 is one of device units of the computer 10, which is battery-operated in the state of being detached from the computer body 1 and can be operated independently of the computer body 1.

On the computer body 1, a sub-display 11, a keyboard 12, a speaker 5B, a microphone 4B, a touch pad 7, a wireless connector 8B, etc. are arranged.

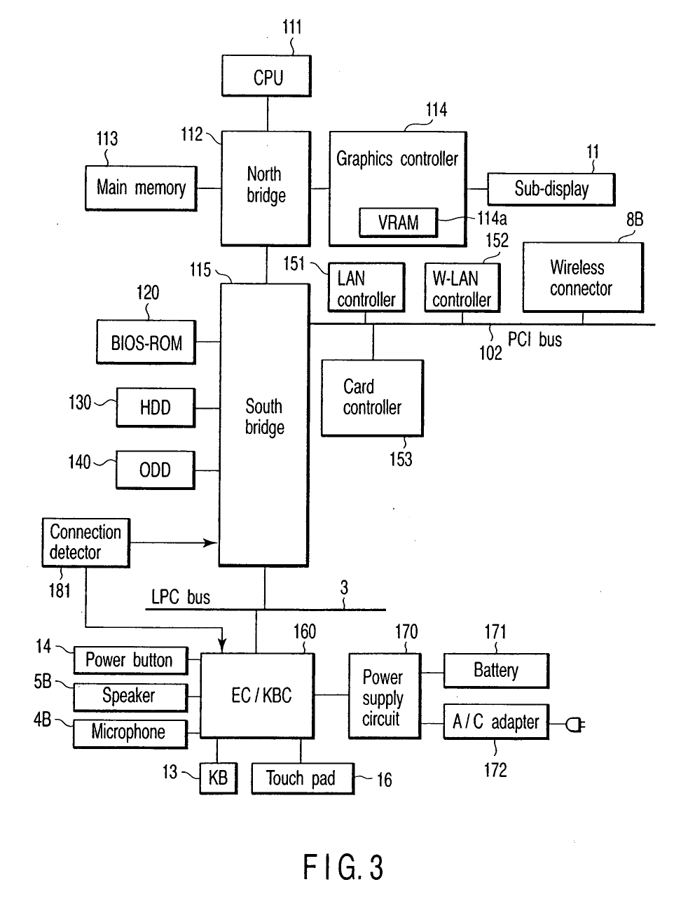

A display device composed of an LCD 17 (Liquid Crystal Display) is embedded in the display unit 2. A display screen of the LCD 17 is located approximately at the center of the display unit 2. A touch panel 32 (FIG. 3) is arranged on, for example, a front surface of the LCD 17.

The display unit 2 is attached to the computer body 1 so as to freely pivot and rotate between an opened position and a closed position, by a hinge 6. The display unit 2 is coupled to the computer body 1 so as to be detachable from the computer body 1, by the hinge 6.

On the display unit 2, a speaker 5A, a microphone 4A, a wireless connector 8A, etc. are further arranged.

The display unit 2 can be rotated in the Y axis around the hinge 6. The display unit 2 also can be folded down in the X axis. For example, when the display unit 2 is folded down with the display surface thereof facing upwardly, the computer body is in the tablet style as shown in FIG. 2. In such a tablet style, for example, two users can watch the display unit 2.

FIG. 3 is a block diagram showing a system configuration of the computer body 1. The computer body 1 comprises a CPU 111, a north bridge 112, a main memory 113, a graphics controller 114, the sub-display 11 and a south bridge 115. The computer body 1 further comprises a BIOS-ROM 120, a hard disk drive (HDD) 130, an optical disc drive (ODD) 140, a LAN controller 151, a wireless LAN controller (W-LAN controller) 152, the wireless connector 8B, a card controller 153, an embedded controller/keyboard controller IC (EC/KBC) 160, a power supply circuit 170, and a connection detector 181.

The CPU 111 is a processor controlling the operations of the computer 10. The CPU 111 executes the operating system (OS) loaded from a boot device such as the HDD 130 to the main memory 113. The CPU 111 also executes various kinds of application programs. In addition, the CPU 111 also executes the system BIOS (Basic Input Output System) stored in the BIOS-ROM 120. The system BIOS is a program for the hardware control.

The north bridge 112 is a bridge device which makes connection between a local bus of the CPU 111 and the south bridge 115. A memory controller controlling accesses to the main memory 113 is built in the north bridge 112. In addition, the north bridge 112 also has a function of executing communication with the graphics controller 114 via an AGP (Accelerated Graphics Port) bus, etc.

The graphics controller 114 is a display controller which controls the LCD 17 and the sub-display 11 employed as a display monitor of the computer 10. The graphics controller 114 has a video memory (VRAM) 114a, and generates a picture signal to form a display image to be displayed on the LCD 17 on the basis of the display data written in the VRAM 114a.

The south bridge 115 controls access to the BIOS-ROM 120. The BIOS-ROM 120 is a rewritable nonvolatile memory such as a flush ROM. As explained above, the BIOS-ROM 120 stores the system BIOS and ID information (identification information) of the display unit 2. The south bridge 115 also controls disc drives (I/O devices) such as the HDD 130 and the ODD 140.

The south bridge 115 is connected to each of a PCI (Peripheral Component Interconnect) bus 102 and an LPC (Low Pin Count) bus 3. The south bridge 115 controls all the devices of the PCI bus 102 and the LPC bus 3. The PCI bus 102 is employed as a system bus.

The HDD 130 is a storage device which stores various kinds of software and data. The HDD 130 executes writing/reading of the data to/from magnetic recording media (magnetic discs) rotated by a motor, by a head (magnetic head). The operating system (OS) is pre-stored in the HDD 130. The OS is executed by the CPU 111, by being loaded on the main memory 113 on the basis of the system BIOS stored in the BIOS-ROM 120.

The ODD 140 is a drive unit which rotates optical recording media (optical discs) such as compact discs (CD) and digital versatile discs (DVD) by a motor. The ODD 140 executes writing/reading of the data to/from optical discs by a head (optical head).

The PCI bus 102 is connected to the LAN controller 151, the W-LAN controller 152 and the card controller 153. The LAN controller 151 is a network computer for connecting the computer body 1 to the LAN (wired LAN). The W-LAN controller 152 is a network controller for connecting the computer body 1 to the wireless LAN. The card controller 153 controls a card device such as a PC card or SD (Secure Digital) card inserted into a card slot connected to the card controller 153.

The EC/KBC 160 is a microcomputer formed by integrating an embedded controller for power supply management, and a keyboard controller which controls the keyboard (KB) 13, speaker 5B, microphone 4B, touch pad 16, etc. on a single chip. The EC/KBC 160 has a power supply control function of turning on the power supply of the computer 10, in response to user's operations of the power button switch 14 by operating in cooperation with the power supply circuit 170. The power supply circuit 170 generates a system power supply voltage to be applied to each of the elements of the computer body 1, by using the DC power supply supplied via a rechargeable battery 171 or an AC adapter 172 serving as a high voltage power supply. The AC adapter 172 converts the AC power supply into the DC power supply.

The connection detector 181 is configured to monitor the attachment/detachment of the display unit 2 to/from the computer body 1. For example, the connection detector 181 generates a low-level signal when the display unit 2 is connected to the computer body 1, and generates a high-level signal when the display unit 2 is detached from the computer body 1. The signals to discriminate the connection/detachment are transmitted to the BIOS via the EC/KBC 160 or transmitted to the BIOS, not via the EC/KBC 160. Notification of the connection/detachment to the BIOS is made via storage means such as a register, etc. For example, when information corresponding to the signal generated from the connection detector 181 is written in a predetermined register provided at the south bridge 115, etc., the BIOS reads the information, recognizes the change of connection/detachment and requests the OS to execute necessary processing (change of the operation mode, etc.)

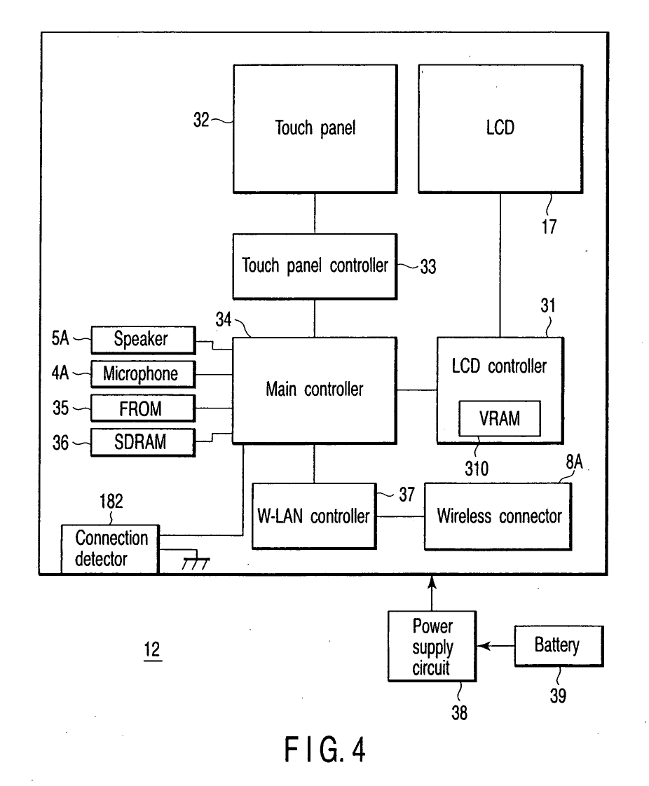

FIG. 4 is a block diagram showing a system configuration of the display unit 2. Besides the LCD 17, the wireless connector 8A, the speaker 5A, and the microphone 4A shown in FIG. 1, the display unit 2 comprises an LCD controller 31, a touch panel 32, a touch panel controller 33, a main controller 34, a flush ROM (FROM: display ROM) 35, a synchronous DRAM (SDRAM) 36, a W-LAN controller 37, a power supply circuit 38, a battery 39 and a connection detector 182.

The LCD controller 31 is a display controller configured to control the LCD 17. The LCD controller 31 is operated when the display unit 2 is used independently in the state of being detached from the computer body 1. The LCD controller 31 has a video memory (VRAM) 310, and generates a picture signal to form a display image which should be displayed on the LCD 17, from display data written in the VRAM 310.

The touch panel 32 has, for example, an input surface which allows position indication when the user touches the panel by finger. The touch panel 32 is transparent and is arranged on, for example, a front face of the LCD 17. The touch panel controller 33 detects the position on the touch panel 32 which the user touches by finger. The user can thereby input instructions directly by finger, for example, for various kinds of menu displayed on the LCD 17 by the LCD controller 31 under control of the main controller 34. Instead of the touch panel 32 and the touch panel controller 33, for example, a tablet (digitizer) which allows position indication using a pen and a tablet controller (digitizer controller) may be employed.

The main controller 34 controls overall operations of the display unit 2. The main controller 34 is composed of, for example, a CPU which executes various kinds of programs stored in the FROM 35 and an I/O controller. The I/O controller controls the data input and output among the LCD controller 31, the touch panel controller 33, the W-LAN controller 37, etc. A part of the area of the SDRAM 36 is used as a work area of the CPU inside the main controller 34. In the present embodiment, the programs stored in the FROM 35 include an Internet viewer program (what is called browser). The FROM 35 further stores ID information, resolution information, security information, etc. of the display unit 2 (described later).

The W-LAN controller 37 is a network controller configured to connect the display unit 2 to the wireless LAN. By the W-LAN controller 37, the main controller 34 allows the display unit 2 to function as an independent Internet viewer, via the wireless connector 8A, under the Internet viewer program. In addition, the main controller 34 also allows the display unit 2 to function as a part of the computer 10 by executing wireless communication, via the W-LAN controller 152 and the wireless connector 8B provided in the computer body 1, by the W-LAN controller 37.

Instead of the wireless communication device executed by the W-LAN controllers 37 and 152, other wireless communication devices such as UWB (ultra wideband) controllers can be employed. If the computer body 1 and the display unit 2 are electrically connected by a connector, for example, communication can be executed between the computer body 1 and the display unit 2 via the PCI bus 102 or LAN line.

The power supply circuit 38 generates a power supply voltage (system power supply voltage) for driving all the elements inside the display unit 2. When the display unit 2 is connected to the computer body 1, the power supply circuit 38 is operated by receiving the system power supply voltage generated by the power supply circuit 170 of the computer body 1. When the display unit 2 is detached from the computer body 1, the power supply circuit 38 is operated by receiving the voltage applied by the battery 39. The battery 39 is a rechargeable battery.

The connection detector 182 is configured to monitor the attachment/detachment of the display unit 2 to/from the computer body 1. For example, the connection detector 182 generates a low-level signal when the display unit 2 is connected to the computer body 1, and generates a high-level signal when the display unit 2 is detached from the computer body 1. The signals to discriminate the connection/detachment are transmitted to, for example, the main controller 34.

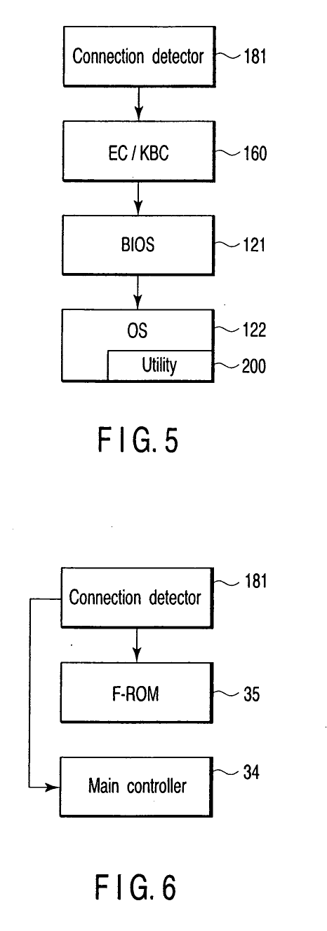

FIG. 5 and FIG. 6 are block diagrams describing signal flows in a case where the display unit 2 is detached from the computer body 1. FIG. 5 shows the signal flow in a case where the connection of the display unit 2 is transmitted to the BIOS via the EC/KBC 16. FIG. 5 shows the signal flow in a case where the detachment of the display unit 2 is transmitted to the main controller 34.

In the case of FIG. 5, when the connection detector 181 detects that the display unit 2 is detached from the computer body 1, the connection detector 181 transmits a signal indicating the detachment to the EC/KBC 160. The EC/KBC 160 transmits the signal indicating the detachment to the BIOS 121 via the register, etc. When the BIOS 121 reads the information written in the register and recognizes the change of state to the detachment, the BIOS 121 transmits the change of state to the OS and requests the OS to execute the necessary processing. Utility 200 managed by OS 122 confirms the contents of setting concerning the detachment of the display unit 2 and then executes the necessary processing.

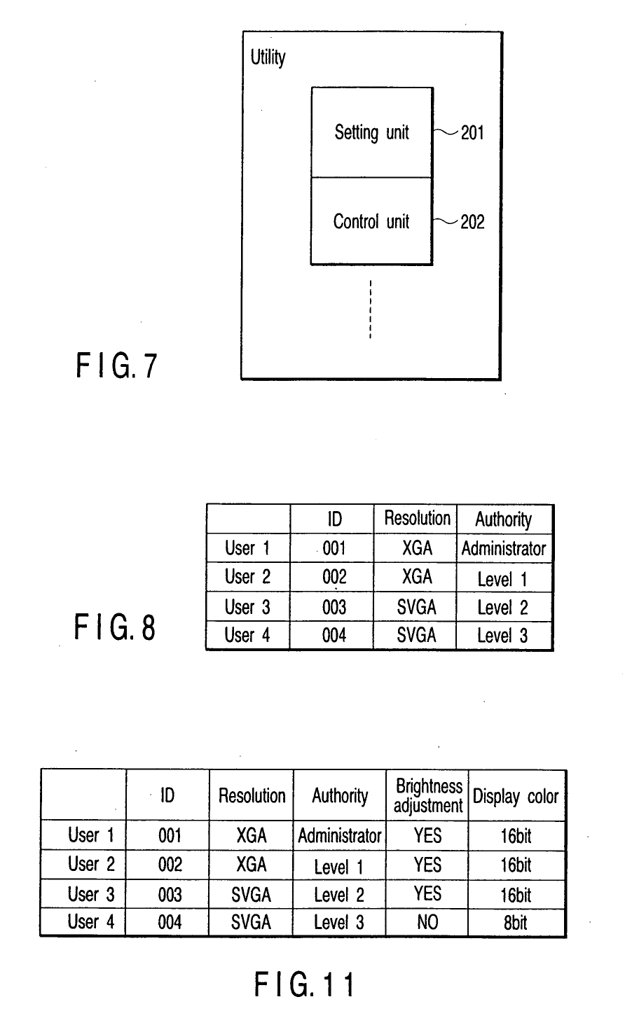

FIG. 7 is a block diagram showing a configuration of the functions of the utility 200 shown in FIG. 5. The utility 200 comprises various kinds of functions such as a setting unit 201, a control unit 202, etc.

The setting unit 201 is a function of setting various kinds of information which the user inputs by the user interface. In the setting unit 201, for example, setting of the “resolution of the display unit 2” changed when predetermined conditions are met and setting of changing or not changing the “resolution of the display unit 2” when the display unit 2 is detached from the computer body 1, can be executed.

The control unit 202 is a function of executing necessary processing on the basis of setting contents which are set in the setting unit 201. For example, the control unit 202 executes a control of changing the “resolution of the display unit 2” when predetermined conditions are met, a control of changing the “resolution of the display unit 2” when the display unit 2 is detached from the computer body 1, etc.

Upon executing a setting of changing or not changing the “resolution of the display unit 2”, in a case where the display unit 2 is detached from the computer body 1, for example, the changing function is changed to be in a disable status. This change of the function corresponds to a case where when the display unit 2 is detached from the computer body 1, the “resolution of the display unit 2” cannot be changed but the same resolution is to be used.

Next, an example of a setting screen implemented by the setting unit 201 of the utility 200 shown in FIG. 7 is described with reference to FIG. 8. For example, if there are four users using the computer 10 (user 1 to user 4), each of the users has a separate display unit. An ID number is assigned to the display unit of each user. For example, ID:001 is assigned to the display unit owned by the user 1, ID:002 is assigned to the display unit owned by the user 2, ID:003 is assigned to the display unit owned by the user 3, and ID:004 is assigned to the display unit owned by the user 4.

Subsequently, the resolution of the display changed when each display unit (ID: 001 to 004) is connected to the computer body 1 is set. For example, XGA is set for ID:001 and ID:002, and SVGA is set for ID:003 and ID:004. When each display unit (ID: 001 to 004) is detached from the computer body 1, the resolution is changed to a lower resolution by one level. For example, the display unit (ID:001) is detached from the computer body 1, the resolution XGA is changed to the lower resolution VGA by one level so as to reduce power consumption of the battery of the display unit (ID:001).

Moreover, the authority of permitting each display unit (ID: 001 to 004) to access the computer body 1 is set. For example, administrator (authority) is set for the display unit (ID:001), level 1 is set for the display unit (ID:002), level 2 is set for the display unit (ID:003), and level 3 is set for the display unit (ID:004). If the display unit (ID:001) set as the administrator is connected, the user is permitted to operate and access all the files. If the display unit (ID:002) set as level 1 is connected, the user is permitted to operate and access the files set in level 1. If the display unit (ID:003) set as level 2 is connected, the user is permitted to operate and access the files set in level 2. If the display unit (ID:004) set as level 3 is connected, the user is permitted to operate and access the files set in level 3. For example, if the computer body 1 and each of display units (ID: 001 to 004) are used generally at home, the administrator is assigned to a father, level 1 is assigned to a mother, and children are assigned to level 2 and level 3. The administrator and level 1 alone are set to access the files which the children cannot access.

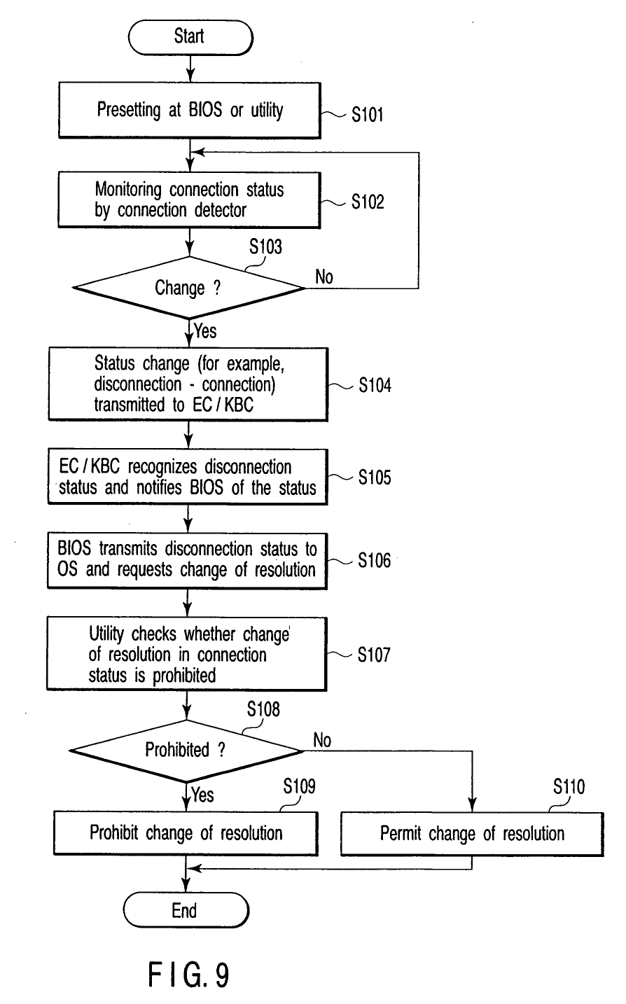

Next, operations in a case where the display unit 2 is connected to the computer body 1 are described with reference to a flow chart of FIG. 9. These operations are executed along with the signal flow shown in FIG. 5 and FIG. 6.

In the BIOS or utility 200, contents designated on the setting screen by the user are preset and prestored in the BIOS-ROM 120 and the FROM (display ROM) 35 (step S101).

After completing the setting, the status of the display unit 2 for the computer body 1 is monitored by the connection detectors 181 and 182 (step S102). If there is no change in the status of the display unit 2 for the computer body 1 (NO in step S103), the monitoring is continued. If there is any change in the status (for example, if the display unit 2 is connected to the computer body 1) (YES in step S103), the connection detector 181 transmits a signal indicating the connection of the display unit 2 to the EC/KBC 160 (step S104).

Thus, the EC/KBC 160 recognizes the change from the detachment status to the connection status of the display unit 2 and transmits information indicating the connection of the display unit 2 to the BIOS 121 via the register, etc. (step S105). When the BIOS 121 reads the information written in the register and recognizes the change of status to the connection, the BIOS 121 notifies the OS of the change of status and requests the OS to execute necessary processing (such as the change of resolution)(step S106). For example, if the display unit of ID:001 is connected, the resolution is changed to XGA of higher resolution (cf. FIG. 8).

The utility 200 managed by the OS 122 discriminates whether the change of resolution should be prohibited on the basis of setting contents (designation of prohibition, conditions of prohibition, etc.) (step S107). If the utility 200 discriminates that the change of resolution should be prohibited (YES in step S108), the change of resolution is prohibited (step S109). If the utility 200 discriminates that the change of resolution should not be prohibited (NO in step S108), the change of resolution is permitted (step s110).

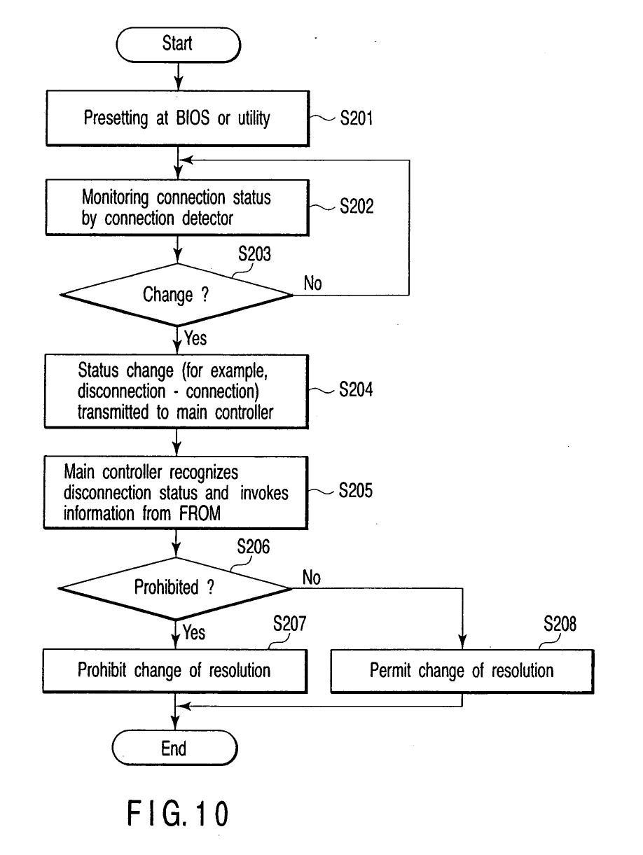

Next, operations in a case where the display unit 2 is detached from the computer body 1 are described with reference to a flow chart of FIG. 10. These operations are executed along with the signal flow shown in FIG. 5 and FIG. 6.

In the BIOS or utility 200, contents designated on the setting screen by the user are preset and prestored in the BIOS-ROM 120 and the FROM (display ROM) 35 (step S201).

After completing the setting, the status of the display unit 2 for the computer body 1 is monitored by the connection detectors 181 and 182 (step S202). If there is no change in the status of the display unit 2 for the computer body 1 (NO in step S203), the monitoring is continued. If there is any change in the status (for example, if the display unit 2 is detached from the computer body 1) (YES in step S203), the connection detector 182 transmits a signal indicating the detachment of the display unit 2 from the computer body 1 to the main controller 34 (step S204).

Thus, the main controller 34 recognizes the change from the connection status to the detachment status of the display unit 2 and invokes change information from the FROM 35 (step S205). The main controller 34 discriminates whether the change of resolution should be prohibited on the basis of the setting contents (designation of prohibition, conditions of prohibition, etc.) (step S206). If the main controller 34 discriminates that the change of resolution should be prohibited (YES in step S206), the change of resolution is prohibited (step S207). If the main controller 34 discriminates that the change of resolution should not be prohibited (NO in step S206), the change of resolution is permitted (step S208).

According to the above embodiment, if the display unit connected to the computer body, the display unit is authenticated and the resolution is changed to the predetermined resolution corresponding to the connected display unit. Thus, each display unit can be used without changing the resolution at the connection of the display unit while maintaining the security. In addition, when the display unit is detached from the computer body, power consumption of the battery of the display unit can be reduced by changing the resolution to lower resolution.

### Other Embodiments

In FIG. 11, setting of brightness adjustment and setting of the display color are added to the setting information of each display unit shown in FIG. 8. Thus, arbitrary setting can be assigned to each of the display units (ID: 001 to 004). For example, if the display unit (ID: 001) is detached from the computer body, the brightness is adjusted since the brightness adjustment is set. In this case, when the display unit (ID: 001) is detached from the computer body, the user feels bright with the same brightness since the resolution is set to be low. Therefore, the brightness may be set to be slightly lower. If the display unit (ID: 001) is connected to the computer body, the brightness is also adjusted since the brightness adjustment is set. In this case, when the display unit (ID: 001) is connected to the computer body, the user feels dark with the same brightness since the resolution is set to be high. Therefore, the brightness may be set to be slightly higher.

In addition, if the display unit (ID: 001) is connected to the computer body, the display color is changed to 16 bit. If the display unit (ID: 001) is detached from the computer body, the set display color is changed to the display color of lower level, similarly to the resolution. In the case of the display unit (ID: 001), since the set display color is 16 bit, it is changed to 8 bit.

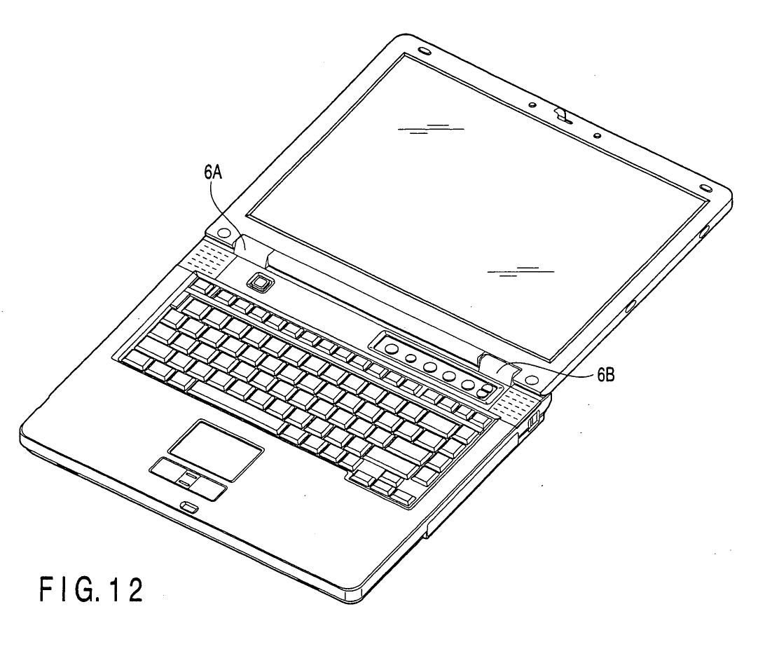

As further another embodiment, a detachable personal computer which is not a tablet PC is shown in FIG. 12.

A display unit is attached to the computer body so as to freely pivot between an opened position and a closed position, by hinges 6A and 6B. The display unit is also coupled to the computer body so as to be detachable from the computer body, by the hinges 6A and 6B.

In such a detachable personal computer which is not a tablet PC, the same advantage as the above-described embodiment can be obtained.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device in which a display unit is detachable from a device body and the display unit and the device body are able to make wireless communication with each other when the display unit is detached from the device body, the electronic device comprising:
a collating unit which collates authentication information assigned to the display unit when the display unit is connected to the device body; and
a changing unit which changes a resolution of the display unit to a preset resolution corresponding to the authentication information when collating the authentication information by the collating unit is completed.

2. The device according to claim 1, further comprising a setting unit which makes it possible to designate whether the resolution of the display unit should be changed when the display unit is connected to the device body.

3. The device according to claim 1, wherein the resolution of the display unit is changed to a lower resolution when the display unit is detached from the device body.

4. The device according to claim 3, further comprising a setting unit which makes it possible to designate whether the resolution of the display unit should be changed to the lower resolution when the display unit is detached from the device body.

5. The device according to claim 1, wherein the changing unit prohibits the change of the resolution of the display unit if the device body and the display unit make communication with each other in the case where the display unit is connected to the device body.

6. The device according to claim 3, wherein the changing unit prohibits the change of the resolution of the display unit if the device body and the display unit make communication with each other in the case where the display unit is detached from the device body.

7. The device according to claim 1, wherein the changing unit changes a security level to a preset security level corresponding to the authentication information when collating the authentication information by the collating unit is completed.

8. The device according to claim 7, wherein the security level of the device is changed to a lowest security level when the display unit is detached from the device body.

9. A method of controlling operations in which a display unit is detachable from a device body and the display unit and the device body are able to make wireless communication with each other when the display unit is detached from the device body, the method comprising:
collating authentication information assigned to the display unit when the display unit is connected to the device body; and
changing a resolution of the display unit to a preset resolution corresponding to the authentication information when collating the authentication information by the collating unit is completed.

10. The method according to claim 9, wherein it is possible to designate whether the resolution of the display unit should be changed when the display unit is connected to the device body.

11. The method according to claim 9, wherein the change of the resolution of the display unit is prohibited if the device body and the display unit make communication with each other in the case where the display unit is connected to the device body.

12. The method according to claim 9, wherein a security level is changed to a preset security level corresponding to the authentication information when collating the authentication information by the collating unit is completed.

13. The method according to claim 10, wherein the security level of the device is changed to a lowest security level when the display unit is detached from the device body.

14. The method according to claim 9, wherein the resolution of the display unit is changed to a resolution lower than a current resolution when the display unit is detached from the device body.
